(19) United States
(12) Patent Application Publication
(10) Pub. No.: US 2021/0149690 A1
(43) Pub. Date: May 20, 2021

(54) SYSTEM AND METHOD TO IMPROVE GRAPHIC USER INTERFACE CONTENT LAYOUT BASED ON USAGE INFORMATION

(71) Applicant: DELL PRODUCTS, LP, Round Rock, TX (US)

(72) Inventors: Parminder Singh Sethi, Ludhian (IN); Madhuri Dwarakanath, Bangalore (IN)

(21) Appl. No.: 16/685,246

(22) Filed: Nov. 15, 2019

(51) Int. Cl. G06F 9/451

(52) U.S. Cl. CPC G06F 9/451

(57) ABSTRACT

An information handling system obtains input pointer information originating from an input pointing device, obtains an existing wireframe model of a graphic user interface (GUI) content layout, and analyzes a user journey through the GUI content layout to obtain usage information. The information handling system may tag regions of the existing wireframe model based on the usage information, and rearrange the existing wireframe model to provide an improved wireframe model representative of an improved GUI content layout.

### CROSS-REFERENCE TO RELATED APPLICATION(S)

The present application is related to co-pending U.S. patent application Ser. No. 16/674,220, entitled “SYSTEM AND METHOD FOR IDENTIFYING USER INTENT USING FOUR-DIMENSIONAL COORDINATES OF AN INPUT POINTER” filed on Nov. 5, 2019 (Attorney Docket No. DC-116938), the entirety of which is herein incorporated by reference.

### FIELD OF THE DISCLOSURE

The present disclosure generally relates to information handling systems, and more particularly a method to improve graphic user interface (GUI) content layout based on usage information.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may obtain input pointer information originating from an input pointing device, obtain an existing wireframe model of a graphic user interface (GUI) content layout, and analyze a user journey through the GUI content layout to obtain usage information. The information handling system may tag regions of the existing wireframe model based on the usage information, and rearrange the existing wireframe model to provide an improved wireframe model representative of an improved GUI content layout.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating tracking of a user's journey on a GUI content layout according to an embodiment of the present disclosure;

FIG. 3 is a block diagram illustrating a user's journey as tracked according to an embodiment of the present disclosure;

FIG. 4 is a block diagram illustrating identification of elements of a GUI content layout based on usage information according to an embodiment of the present disclosure; and

FIG. 5 is a flow diagram illustrating a method according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

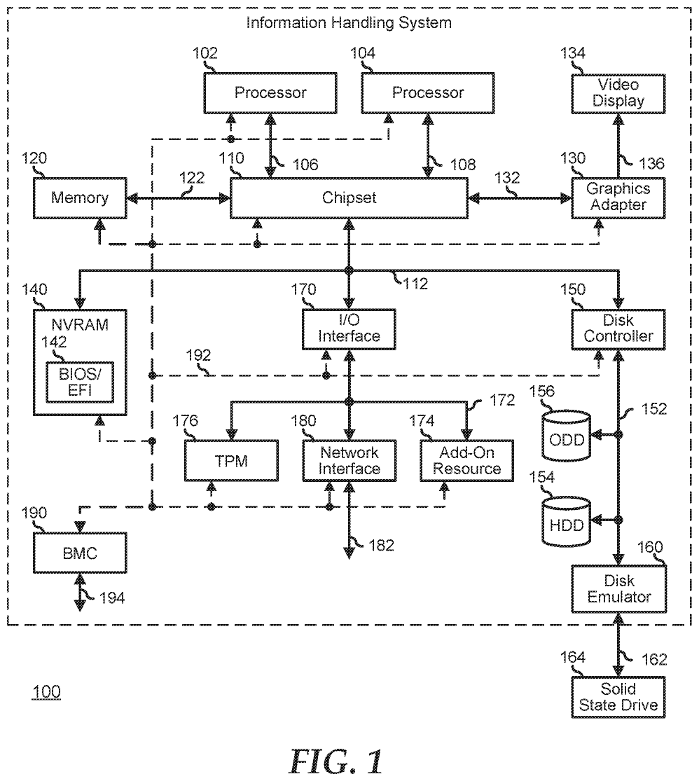

FIG. 1 illustrates a generalized embodiment of information handling system 100. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described above, and operates to perform one or more of the methods described above. Information handling system 100 includes a processors 102 and 104, a chipset 110, a memory 120, a graphics adapter 130, include a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics adapter 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a Serial Peripheral Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1194 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniB and channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

BMC 190 is connected by a management interface 192 to a plurality of system components, such as processor 102, processor 104, memory 120, chipset 110, graphics adapter 130, I/O interface 170, disk controller 150, NVRAM module 140, TPM 176, network interface 180, and add-on resource 174. BMC 190 is connected to an external management interface 194 for platform management by an external IHS.

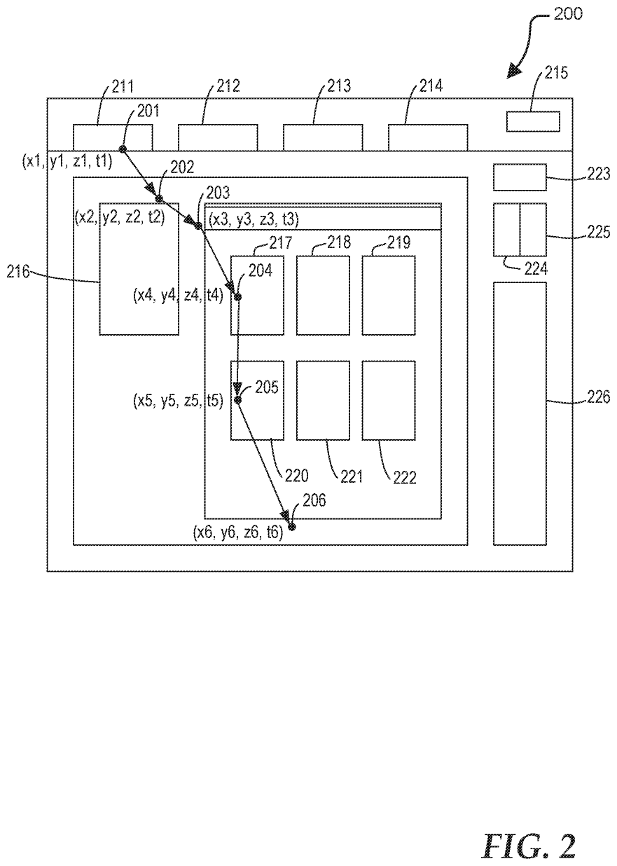

FIG. 2 is a block diagram illustrating tracking of a user's journey on a GUI content layout according to an embodiment of the present disclosure. GUI content layout 200 comprises tabs 211, 212, 213, and 214, user account tool 215, data graph 216, topical items 217, 218, 219, 220, 221, and 222, overview panel 223, management item enumerations 224 and 225, and report 226, which are exemplary among a wide variety of possible elements that may or may not be included in a GUI content layout, such as GUI content layout 200. With respect to GUI content layout 200, a user's journey is depicted, including points obtained from input pointer device coordinates and paths between them, which form a trajectory of user input information. Point 201 is placed based on a user's input by positioning an input pointing device to point to a point whose coordinates are (x1, y1, z1, t1). Point 202 is placed based on a user's input by positioning an input pointing device to point to a point whose coordinates are (x2, y2, z2, t2). Point 203 is placed based on a user's input by positioning an input pointing device to point to a point whose coordinates are (x3, y3, z3, t3). Point 204 is placed based on a user's input by positioning an input pointing device to point to a point whose coordinates are (x4, y4, z4, t4). Point 205 is placed based on a user's input by positioning an input pointing device to point to a point whose coordinates are (x5, y5, z5, t5). Point 206 is placed based on a user's input by positioning an input pointing device to point to a point whose coordinates are (x6, y6, z6, t6). As shown, point 201 is on tab 211, points 202 and 203 are on a portion of the trajectory from tab 211 to topical item 217, point 204 is on topical item 217, point 205 is on topical item 220, and point 206 extends the trajectory beyond topical item 220.

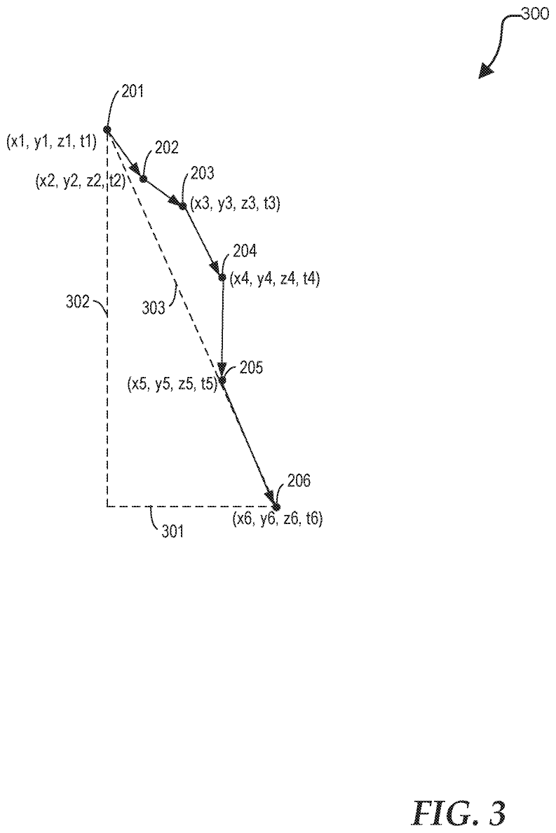

FIG. 3 is a block diagram illustrating a user's journey as tracked according to an embodiment of the present disclosure. User journey 300 comprises points 201, 202, 203, 204, 205, and 206 and the paths from each one to the next. Points 201, 202, 203, 204, 205, and 206 span a horizontal range 301, a vertical range 302, and a displacement 303. Horizontal range 301 extends from coordinate x1 to coordinate x6. Horizontal range 301 can be calculated by subtracting a horizontal coordinate x1 of point 201 from a horizontal coordinate x6 of point 206. To avoid making an assumption that point 201 is the leftmost point and point 206 is the rightmost point, the horizontal coordinates of each of points 201, 202, 203, 204, 205, and 206 could be compared to each other to find the one having the lowest value of its horizontal coordinate, which would be the leftmost point, and to find the one having the highest value of its horizontal coordinate, which would be the leftmost point. Horizontal range 301 would be the difference of the highest-valued horizontal coordinate and the lowest-valued horizontal coordinate. Vertical range 302 extends from coordinates y1 and z1 to coordinates y6 and z6. In the event no scrolling has occurred, as indicated by the z coordinates of the points remaining unchanged, vertical range 302 can be calculated by subtracting the vertical coordinate y1 of point 201 from the vertical coordinate y6 of point 206. To avoid making an assumption that point 201 is the uppermost point and point 206 is the lowermost point, the vertical coordinates of each of points 201, 202, 203, 204, 205, and 206 could be compared to each other to find the one having the lowest value of its vertical coordinate, which would be the uppermost point (assuming the vertical coordinate values ascend in a downward direction), and to find the one having the highest value of its vertical coordinate, which would be the leftmost point (assuming the vertical coordinate values ascend in a downward direction). Horizontal range 301 would be the difference of the highest-valued horizontal coordinate and the lowest-valued horizontal coordinate. In the event that scrolling occurs, a combination of the vertical coordinate (y coordinate) value and the scrolling coordinate (z coordinate) value can be used in place of the vertical coordinate (y coordinate) value described above. For example, a combination may be determined by adding a vertical coordinate (y coordinate) value to the product of its corresponding scrolling coordinate (z coordinate) value (divided by one hundred in the case of a percentage) times the overall height of the contiguous presentation of displayable information through which the scrolling may be performed. The combined value so obtained may be used in place of the vertical coordinate (y coordinate) value described above to determine the vertical range, as well as to determine displacement 303 in the event of scrolling, as will be described below. As another example, vertical coordinate values that ascend in an upward direction can be accommodated by subtracting them from a screen height of the display screen In the case of scrolling, such a difference can be added to the product of the vertical coordinate value's corresponding scrolling coordinate (z coordinate) value (divided by one hundred in the case of a percentage) times the overall height of the contiguous presentation of displayable information through which the scrolling may be performed. Displacement 303 extends from coordinate x1 to coordinate x6 in the x direction and from coordinates y1 and z1 to coordinates y6 and z6 in the y and z direction. Displacement 303 can be determined, for example, by determining the square root of the sum of the square of the horizontal range 301 and the square of the vertical range 302. In the event that an intermediate point, such as any of points 202, 203, 204, or 205, provided excursion beyond the values of the coordinates of terminal points 201 and 206, one or more of horizontal range 301, vertical range 302, and displacement 303 could be defined with respect to one or more coordinates of one or more of an intermediate point instead of one or more of the terminal points. For example, if coordinate x5 of point 205 were greater than coordinate x6 of point 206, horizontal range 301 could extend from coordinate x1 of point 201 to coordinate x5 of point 205, and displacement 303 could be adjusted accordingly based on horizontal range 301. A speed of movement over the displacement 303 can be determined by dividing the displacement 303 by the different in time indicated by a difference in time coordinates (t coordinates) of the points at the ends of the displacement 303. For example, to determine a speed of movement from point 201 to point 206, the square root of the sum of the square of the difference between horizontal coordinate value x6 of point 206 and horizontal coordinate value x1 of point 201 and the square of the difference between vertical coordinate value y6 of point 206 and vertical coordinate value y1 of point 201 (in a non-scrolling example) can be divided by the difference between time coordinate value t6 of point 206 and time coordinate value t1 of point 201. Analysis with finer granularity of the trajectory can be performed by performing the above determinations with respect to more closely spaced points, such as between point 201 and point 202, between point 202 and point 203, between point 203 and point 204, between point 204 and point 205, and between point 205 and point 206. Analysis with intermediate granularity of the trajectory can be performed by performing the above determinations with respect to other combinations of points, such as between point 201 and point 203 and between point 203 and point 206.

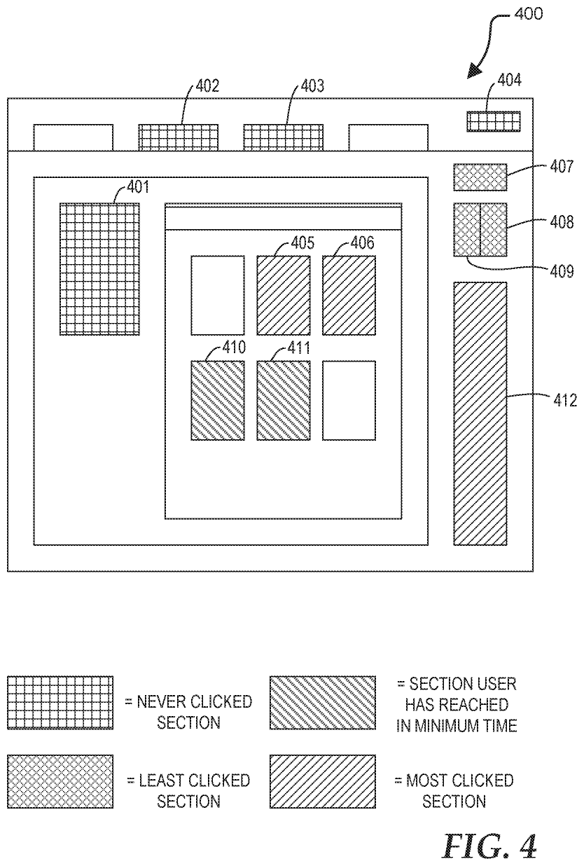

FIG. 4 is a block diagram illustrating identification of elements of a GUI content layout based on usage information according to an embodiment of the present disclosure. Evaluation output 400 for GUI content layout 200 shows the wireframe elements of GUI content layout 200 and also includes indications of results of evaluation of usage of GUI content layout 200 by one or more users. Evaluation performed on usage information shows regions 401, 402, 403, and 404, corresponding respectively to data graph 216, tabs 212 and 213, and user account tool 205, as never having been clicked by a user, as denoted by horizontal and vertical crosshatching, labelled “never clicked section.” Evaluation performed on the usage information shows regions 407, 408, and 409, corresponding respectively to overview panel 223, management item enumeration 224, and management item enumeration 225, as being among the least clicked sections, as denoted by diagonal crosshatching, labelled “least clicked section.” Evaluation performed on the usage information shows regions 405 and 406, corresponding respectively to topical items 218 and 219, as being among the most clicked sections, as denoted by hatching rising diagonally from left to right, labelled “most clicked section.” Evaluation performed on the usage information shows regions 410 and 411, corresponding respectively to topical items 220 and 221, as being sections the user has reached in a minimum amount of time, labelled “section user have reached in minimum time.”

Based on evaluation output 400, the GUI content layout 200 can be improved by rearranging, adding, or deleting elements of GUI content layout 200. As an example, data graph 216 in never-clicked region 401 could be relocated to a position where it is visible but out of the way of a user trajectory to more frequently used elements, such as topical items 218 and 219 in most-clicked regions 405 and 406. As an example, topical items 218 and 219 could be moved to the left of data graph 216, and data graph 216 could be moved to the right of topical items 218 and 219. Thus, automatic improvement of wireframes can be provided and can provide automatic improvement of GUI content layout and functionality.

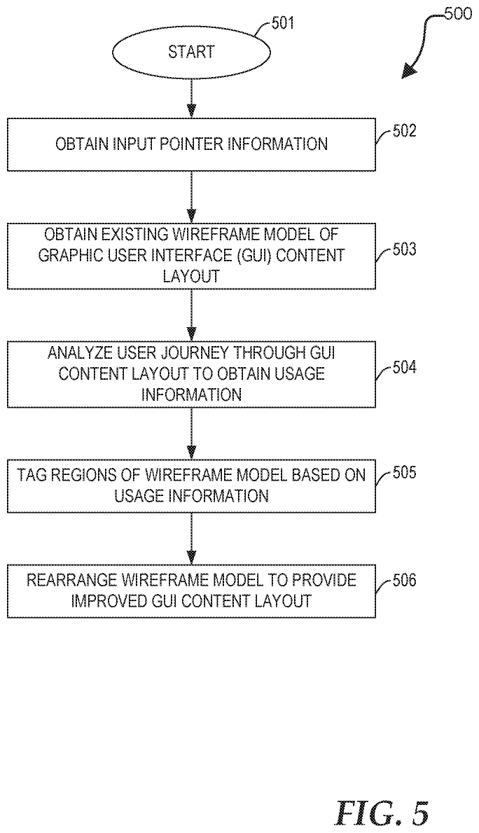

FIG. 5 is a flow diagram illustrating a method according to an embodiment of the present disclosure. Method 500 begins at block 501 and continues to block 502. At block 502, an IHS obtains input pointer information. The input pointer information is information obtained from an input pointing device, such as a mouse, a trackball, a glide pad, a touchscreen, a gesture detection system, a graphics input tablet, the like, or a combination thereof. As an example, input pointer information can include coordinates, which can indicate position, movement, or both, of a location of focus, such as a mouse pointer, of a user's interaction with a GUI. From block 502, method 500 continues to block 503. At block 503, the IHS obtains an existing wireframe model of the GUI content layout. From block 503, method 500 continues to block 504. At block 504, the IHS analyzes a user journey through the GUI content layout to obtain usage information. As an example, among the input pointer information, combinations of points and times at which they occur along the user journey can define a user trajectory through elements presented via the GUI. By mapping such a trajectory to the GUI content layout modeled by the wireframe model, usage information may be obtained in space and time. From block 504, method 500 continues to block 505. At block 505, the IHS tags regions of the wireframe model based on the usage information. Examples of such tagging can be seen in FIG. 4. From block 505, method 500 continues to block 506. At block 506, the IHS rearranges the wireframe model to provide an improved GUI content layout. As an example, an optimization process may be used to implement the rearrangement. For example, two or more elements of the GUI content layout may be rearranged relative to one another as a proposed rearrangement. Then, the usage information previously obtained from the journeys of one or more users can be used to simulate the performance by the one or more users of the same journeys through the proposed rearrangement of the GUI content layout. Metrics can be obtained on simulated usage information of the proposed rearrangement to yield an evaluation output similar to the evaluation output shown in FIG. 4, but for the proposed rearrangement. The evaluation output of the existing GUI content layout can be compared to the evaluation output for the proposed rearrangement of the GUI content layout. If the evaluation output of the proposed rearrangement of the GUI content layout is judged to be superior to the evaluation output of the existing GUI content layout, the GUI content layout can be automatically rearranged by rearranging the wireframe model to provide an improved GUI content layout according to the proposed rearrangement. If the proposed rearrangement were not found to be superior, alternative proposed rearrangements can be proposed and evaluated until a superior rearrangement is identified, at which point the GUI content layout can be automatically rearranged by rearranging the wireframe model to provide an improved GUI content layout according to the superior rearrangement. Even if the proposed rearrangement is judged to be superior, alternative proposed rearrangement can be proposed and evaluated, either based on the same input pointer information or as new input pointer information becomes available, to continue to favorably refine the GUI content layout.

Software applications executed on an information handling system (IHS) typically provide for the visual display of information to a user via a graphic user interface (GUI). For example, the GUI may be instantiated in hardware using video display 134 of FIG. 1. The content to be displayed via the GUI is laid out to allow a user to select desired information and functions. As an example, a menu or a series of tabs may allow a user to select among a plurality of pages of information or functions to be performed. The arrangement of the GUI content layout may be defined or expressed using wireframes, which are shapes and connections used to denote the relationships of the elements of the GUI content layout without full rendering of the elements themselves. There are multiple approaches that the user interface/user experience (UI/UX) teams adopt to design wireframes. These approaches are built on the assumption of a generic user's behavior. These assumptions may be not appropriate and may not always be used as a reference to design products. For example, individuals of different age groups, genders, mindsets, and so on may use the same application in different ways and also have different approaches towards using an application. By designing wireframes according to an assumption of a generic user's behavior, UI/UX teams do not necessarily design wireframes that are compatible across a majority of actual users.

Accordingly, a method and apparatus are described herein to reveal not only the most used features or the least used features but also the reachability of the features for a user navigating the GUI content layout. Based on such information, guidance is provided as to how and where elements can be placed for better reachability. Hence, recommendations can be made for the improved wireframes, which improve the usability of a GUI.

Input pointer information from an input pointer device, such as a mouse device, can be obtained to determine movement of an input pointing device by a user as the user selects features accessible via a GUI. The input pointer information can be recorded as four-dimensional coordinate values, where the dimensions can be an x axis, a y axis orthogonal to the x axis, a z axis representative of an amount of scrolling in a direction of the y axis, and a t axis representative of time. The input pointer information can be collected from an IHS and uploaded to a server.

The input pointer information can be analyzed to reconstruct a user's trajectory through the GUI content layout based on the user's usage of the GUI. The analysis can be conducted specifically for a particular user or can be conducted across a range of experiences of a plurality of users using the GUI. As one example, analysis can be applied generally to produce an improved common GUI content layout to be provided to a plurality of users. As another example, analysis can be applied specifically to produce an improved specific GUI content layout to be provided to a specific subset of the plurality of users (e.g., to a specific single user) without being generalized to other users.

In accordance with at least one embodiment, a method is provided to find how and where elements can be placed for better reachability. In accordance with at least one embodiment, a method provides automation of wireframe creation without any human intervention. Such a method can include evaluation of various external factors, such as different users' behavior when using the same application. In accordance with at least one embodiment, a tag is applied to a portion of a particular instance of a GUI content layout. The tag can be applied according to one or more of the following factors, which can be used to design an improved wireframe for the GUI content layout: sections that are least clicked, sections with most number of clicks, sections on which the user spends the longest time, sections on which the user spends the shortest time, sections which the user reaches with maximum time, and sections which the user reaches with minimum time.

In accordance with at least one embodiment, a method comprises obtaining, at an information handling system (IHS), input pointer information originating from an input pointing device; obtaining, at the IHS, an existing wireframe model of a graphic user interface (GUI) content layout; analyzing, at the IHS, a user journey through the GUI content layout to obtain usage information; tagging, at the IHS, regions of the existing wireframe model based on the usage information; and rearranging, at the IHS, the existing wireframe model to provide an improved wireframe model representative of an improved GUI content layout. In accordance with at least one embodiment, the rearranging comprises proposing, at the IHS, a proposed rearrangement of two or more elements of the existing wireframe model based on the tagging; performing, at the IHS, simulated usage of the proposed rearrangement according to the user journey to obtain simulated usage information; and evaluating, at the IHS, the proposed rearrangement based on the simulated usage information. In accordance with at least one embodiment, the rearranging further comprises judging, at the IHS, the proposed rearrangement to be superior based on the simulated usage information; and adopting, at the IHS, the improved wireframe model to provide the improved GUI content layout. In accordance with at least one embodiment, the rearranging further comprises judging, at the IHS, the proposed rearrangement not to be superior based on the simulated usage information; proposing, at the IHS, an alternative proposed rearrangement of two or more elements of the existing wireframe model based on the tagging; performing, at the IHS, simulated usage of the alternative proposed rearrangement according to the user journey to obtain simulated usage information; and evaluating, at the IHS, the alternative proposed rearrangement based on the simulated usage information. In accordance with at least one embodiment, the rearranging further comprises, after the adopting, continuing, at the IHS, to propose and evaluate alternative proposed rearrangements for possible superiority to the improved wireframe model. In accordance with at least one embodiment, the continuing is a based on the input pointer information previously obtained. In accordance with at least one embodiment, the continuing is based on newly available input pointer information.

In accordance with at least one embodiment, an information handling system (IHS) comprises memory and a processor, the processor configured to obtain input pointer information originating from an input pointing device, to obtain an existing wireframe model of a graphic user interface (GUI) content layout, to analyze a user journey through the GUI content layout to obtain usage information, to tag regions of the existing wireframe model based on the usage information, and to rearrange the existing wireframe model to provide an improved wireframe model representative of an improved GUI content layout. In accordance with at least one embodiment, the processor is further configured to propose a proposed rearrangement of two or more elements of the existing wireframe model based on the tagging, to perform simulated usage of the proposed rearrangement according to the user journey to obtain simulated usage information, and to evaluate the proposed rearrangement based on the simulated usage information. In accordance with at least one embodiment, the processor is further configured to judge the proposed rearrangement to be superior based on the simulated usage information and to adopt the improved wireframe model to provide the improved GUI content layout. In accordance with at least one embodiment, the processor is further configured to judge the proposed rearrangement not to be superior based on the simulated usage information, to propose an alternative proposed rearrangement of two or more elements of the existing wireframe model based on the tagging, to perform simulated usage of the alternative proposed rearrangement according to the user journey to obtain simulated usage information, and to evaluate the alternative proposed rearrangement based on the simulated usage information. In accordance with at least one embodiment, the processor is further configured to continue, after the adopting, to propose and evaluate alternative proposed rearrangements for possible superiority to the improved wireframe model. In accordance with at least one embodiment, the continuing is a based on the input pointer information previously obtained. In accordance with at least one embodiment, the continuing is based on newly available input pointer information.

In accordance with at least one embodiment, a method comprises obtaining, at an information handling system (IHS), input pointer information originating from an input pointing device; obtaining, at the IHS, an existing wireframe model of a graphic user interface (GUI) content layout; analyzing, at the IHS, a plurality of user journeys through the GUI content layout to obtain usage information; qualifying, at the IHS, regions of the existing wireframe model based on the usage information, the qualifying reflective of access qualities of the regions with respect to the usage information; and rearranging, at the IHS, the existing wireframe model to provide an improved wireframe model representative of an improved GUI content layout. In accordance with at least one embodiment, the rearranging further comprises proposing, at the IHS, a proposed rearrangement of two or more elements of the existing wireframe model based on the tagging; performing, at the IHS, simulated usage of the proposed rearrangement according to the user journey to obtain simulated usage information; and evaluating, at the IHS, the proposed rearrangement based on the simulated usage information. In accordance with at least one embodiment, the rearranging further comprises judging, at the IHS, the proposed rearrangement to be superior based on the simulated usage information; and adopting, at the IHS, the improved wireframe model to provide the improved GUI content layout. In accordance with at least one embodiment, the rearranging further comprises judging, at the IHS, the proposed rearrangement not to be superior based on the simulated usage information; proposing, at the IHS, an alternative proposed rearrangement of two or more elements of the existing wireframe model based on the tagging; performing, at the IHS, simulated usage of the alternative proposed rearrangement according to the user journey to obtain simulated usage information; and evaluating, at the IHS, the alternative proposed rearrangement based on the simulated usage information. In accordance with at least one embodiment, the rearranging further comprises, after the adopting, continuing, at the IHS, to propose and evaluate alternative proposed rearrangements for possible superiority to the improved wireframe model. In accordance with at least one embodiment, the continuing is based on newly available input pointer information.

For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, the information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, the information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. Information handling systems can also include one or more buses operable to transmit information between the various hardware components.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories.

Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. A method comprising:
obtaining, at an information handling system (IHS), input pointer information originating from an input pointing device;
obtaining, at the IHS, an existing wireframe model of a graphic user interface (GUI) content layout;
analyzing, at the IHS, a user journey through the GUI content layout to obtain usage information, the user journey comprising points and paths from each point of the points to a next point of the points, respectively;
tagging, at the IHS, regions of the existing wireframe model based on the usage information; and
rearranging, at the IHS, the existing wireframe model to provide an improved wireframe model representative of an improved GUI content layout.

2. The method of claim 1, wherein the rearranging comprises:
proposing, at the IHS, a proposed rearrangement of two or more elements of the existing wireframe model based on the tagging;
performing, at the IHS, simulated usage of the proposed rearrangement according to the user journey to obtain simulated usage information; and
evaluating, at the IHS, the proposed rearrangement based on the simulated usage information.

3. The method of claim 2, wherein the rearranging further comprises:
judging, at the IHS, the proposed rearrangement to be superior based on the simulated usage information; and
adopting, at the IHS, the improved wireframe model to provide the improved GUI content layout.

4. The method of claim 2, wherein the rearranging further comprises:
judging, at the IHS, the proposed rearrangement not to be superior based on the simulated usage information;
proposing, at the IHS, an alternative proposed rearrangement of the two or more elements of the existing wireframe model based on the tagging;
performing, at the IHS, simulated usage of the alternative proposed rearrangement according to the user journey to obtain simulated usage information; and
evaluating, at the IHS, the alternative proposed rearrangement based on the simulated usage information.

5. The method of claim 3, wherein the rearranging further comprises:
after the adopting, continuing, at the IHS, to propose and evaluate alternative proposed rearrangements for possible superiority to the improved wireframe model.

6. The method of claim 5, wherein the continuing is based on the input pointer information previously obtained.

7. The method of claim 6, wherein the continuing is based on newly available input pointer information.

8. An information handling system (IHS) comprising:
memory; and
a processor in communication with the memory, the processor configured to obtain input pointer information originating from an input pointing device, to obtain an existing wireframe model of a graphic user interface (GUI) content layout, to analyze a user journey through the GUI content layout to obtain usage information, to tag regions of the existing wireframe model based on the usage information, and to rearrange the existing wireframe model to provide an improved wireframe model representative of an improved GUI content layout, the user journey comprising points and paths from each point of the points to a next point of the points, respectively.

9. The IHS of claim 8, wherein the processor is further configured to propose a proposed rearrangement of two or more elements of the existing wireframe model based on the tagging, to perform simulated usage of the proposed rearrangement according to the user journey to obtain simulated usage information, and to evaluate the proposed rearrangement based on the simulated usage information.

10. The IHS of claim 9, wherein the processor is further configured to judge the proposed rearrangement to be superior based on the simulated usage information and to adopt the improved wireframe model to provide the improved GUI content layout.

11. The IHS of claim 9, wherein the processor is further configured to judge the proposed rearrangement not to be superior based on the simulated usage information, to propose an alternative proposed rearrangement of the two or more elements of the existing wireframe model based on the tagging, to perform alternative simulated usage of the alternative proposed rearrangement according to the user journey to obtain alternative simulated usage information, and to evaluate the alternative proposed rearrangement based on the alternative simulated usage information.

12. The IHS of claim 11, wherein the processor is further configured to continue, after adopting the improved wireframe model, to propose and evaluate alternative proposed rearrangements for possible superiority to the improved wireframe model.

13. The IHS of claim 12, wherein the continuing is based on the input pointer information previously obtained.

14. The IHS of claim 12, wherein the continuing is based on newly available input pointer information.

15. A method comprising:
obtaining, at an information handling system (IHS), input pointer information originating from an input pointing device;
obtaining, at the IHS, an existing wireframe model of a graphic user interface (GUI) content layout;
analyzing, at the IHS, a plurality of user journeys through the GUI content layout to obtain usage information, each of the user journeys comprising points and paths from each point of the points to a next point of the points, respectively;
qualifying, at the IHS, regions of the existing wireframe model based on the usage information, the qualifying reflective of access qualities of the regions with respect to the usage information, the access qualities comprising four-dimensional coordinate values with respect to an x axis, a y axis orthogonal to the x axis, a z axis representative of an amount of scrolling in a direction of the y axis, and a t axis representative of time; and
rearranging, at the IHS, the existing wireframe model to provide an improved wireframe model representative of an improved GUI content layout.

16. The method of claim 15, wherein the rearranging further comprises:
proposing, at the IHS, a proposed rearrangement of two or more elements of the existing wireframe model;
performing, at the IHS, simulated usage of the proposed rearrangement according to the user journey to obtain simulated usage information; and
evaluating, at the IHS, the proposed rearrangement based on the simulated usage information.

17. The method of claim 16, wherein the rearranging further comprises:
judging, at the IHS, the proposed rearrangement to be superior based on the simulated usage information; and
adopting, at the IHS, the improved wireframe model to provide the improved GUI content layout.

18. The method of claim 16, wherein the rearranging further comprises:
judging, at the IHS, the proposed rearrangement not to be superior based on the simulated usage information;
proposing, at the IHS, an alternative proposed rearrangement of the two or more elements of the existing wireframe model;
performing, at the IHS, alternative simulated usage of the alternative proposed rearrangement according to the user journey to obtain alternative simulated usage information; and
evaluating, at the IHS, the alternative proposed rearrangement based on the alternative simulated usage information.

19. The method of claim 17, wherein the rearranging further comprises:
after the adopting, continuing, at the IHS, to propose and evaluate alternative proposed rearrangements for possible superiority to the improved wireframe model.

20. The method of claim 19, wherein the continuing is based on newly available input pointer information.
